(19) United States
(12) Patent Application Publication
(10) Pub. No.: US 2012/0077061 A1
(43) Pub. Date: Mar. 29, 2012

(54) Nickel-Metal Hydride Accumulator

(75) Inventors: Detlef Ohms, Gottingen (DE); Gunter Schädlich, Neukirchen (DE); Boris Kleinschnittger, Brilon (DE); Rainer Markolf, Twistetal (DE); Katja Schmelter, Brilon (DE)

(73) Assignee: HOPPECKE BATTERIE SYSTEME GMBH, Brilon (DE)

(21) Appl. No.: 13/245,942

(22) Filed: Sep. 27, 2011

(30) Foreign Application Priority Data
Sep. 27, 2010 (DE) 10 2010 046 647.6

(51) Int. Cl. H01M 2/12

(52) U.S. Cl. 429/53

(57) ABSTRACT

A nickel-metal hydride accumulator for industrial applications has positive nickel hydroxide electrodes and, separated therefrom, negative metal hydride electrodes as well as an alkaline electrolyte surrounding the electrodes. An improved nickel-metal hydride accumulator that is in particular insensitive to influences of temperature has a thermal arrangement which increases the specific thermal capacity of the accumulator and is formed by an additional electrolyte volume, wherein the accumulator comprises a plastics material housing which receives the electrodes and the electrolyte and is provided with a pressure relief valve.

### BACKGROUND OF THE INVENTION

The invention relates to a nickel-metal hydride accumulator for industrial applications, comprising positive nickel hydroxide electrodes and, separated therefrom, negative metal hydride electrodes as well as an alkaline electrolyte surrounding the electrodes.

Nickel-metal hydride accumulators, NiMH accumulators for short, are known per se from the prior art, and it is not therefore necessary to detail a specific list or prior art documents in this regard.

Nickel-metal hydride accumulators have a positive electrode made of nickel hydroxide. The negative electrode is formed of a metal hydride. An alkaline solution, for example a caustic potash solution, is used as an electrolyte.

Nickel-metal hydride accumulators have proven in practice to be expedient in day-to-day use. Compared to nickel-cadmium accumulators, they provide approximately double the energy density at the same voltage. Furthermore, they are more durable than nickel-cadmium accumulators and do completely without the toxic heavy metal cadmium.

However, nickel-metal hydride accumulators disadvantageously react sensitively to overheating. Such an overheating may arise as a result of overcharging, for example. Overheating may result in a decrease in charge, that is to say the capacity of the nickel-metal hydride accumulator, resulting in a reduced service life.

DE 10 2008 044 162 A1 discloses a battery in which at least one heat-conducting element is arranged to increase thermal conductivity. The heat-conducting element proposed in this case is basically designed as a rod- or plate-shaped element made of metal. With this design DE 10 2008 044 162 A1 aims to achieve both increased thermal conductivity to reduce the temperature at high charging or discharging rates, and quicker heating of the battery to a specific minimum cell temperature at low temperatures. DE 10 2008 044 162 A1 therefore proposes using a solid member as a heat-conducting element, more specifically a metal element, wherein a heat-conducting element having maximum thermal conductivity should be used since the teaching according to DE 10 2008 044 162 A1 deals with obtaining the quickest possible heat distribution within the battery so that the quickest possible heating to a minimum cell temperature can be attained, even at low temperatures.

WO 99/26802 discloses a drive system for hybrid electric vehicles comprising an NIMH battery module which supplies high specific energy to increase the working range of the vehicle and also exhibits good thermal management. The latter is to be achieved by heat-conductive material additions to the electrodes. For example, these material additions may be provided in a plating of the electrodes with a conductive material. Similarly to the aforementioned DE 10 2008 044 162 A1, WO 99/26802 also relates to the attainment of an increase in the thermal conductivity within the battery.

DE 198 23 916 A1 discloses a battery which comprises a liquid electrolyte circulation device for circulating the electrolyte. The stoichiometric ratio of acid in the different areas of the battery is to be improved by this circulation, and therefore an improved utilisation of the electrode surface is to be achieved. A heating or cooling system which circulates the electrolyte by convection is installed for when the battery is stationary, that is to say in the event that the vehicle carrying the battery is therefore not moving.

A maintenance-free industrial accumulator is known from U.S. Pat. No. 6,680,140 61, more specifically an accumulator of open design. It is proposed, in order to avoid the loss of water caused by overcharging and therefore to avoid an overheating of the accumulator, to provide an excessive amount of electrolyte compared to the amount limited to the pores of the components, wherein the excess electrolyte is stored, at least in part, between the base of an electromechanical cluster and the base of the container, and wherein an additional device is used to recombine the oxygen. This arrangement is intended to ensure that the electromechanical cluster does not dry out during the three operating phases of the accumulator presented.

Starting from the situation described above, the object of the invention is to propose a nickel-metal hydride accumulator which is improved compared to the prior art and which, in particular, is not sensitive to influences of temperature.

### SUMMARY OF THE INVENTION

In order to achieve this object, the invention proposes a nickel-metal hydride accumulator which is characterised by a thermal arrangement which increases the specific thermal capacity of the accumulator and is formed by an additional electrolyte volume, wherein the accumulator comprises a plastics material housing which receives the electrodes and the electrolyte and has a pressure relief valve.

The accumulator according to the invention is equipped with a thermal device which increases the specific thermal capacity of the accumulator. Owing to this design, the nickel-metal hydride accumulator according to the invention can absorb additional thermal energy without overheating. The nickel-metal hydride accumulator according to the invention is thus less susceptible to influences of temperature, whereby the charge, that is to say the capacity of the accumulator, is advantageously decreased at least to a lesser extent, if at all in the event of an influence of temperature, in contrast to the prior art. The overall service life of the accumulator is consequently extended.

The design according to the invention allows the increased use of nickel-metal hydride accumulators in industrial applications, for example as battery hybrid vehicles. The risk of overheating as a result of overcharging is minimised thanks to the design according to the invention, whereby the accumulator according to the invention is more user-friendly compared to accumulators known from the prior art.

In accordance with the invention the thermal arrangement is formed by an additional electrolyte volume. For ordinary operation of an accumulator of the generic type, enough electrolyte is provided that the electrodes or separators separating the electrodes from one another are surrounded by electrolyte, that is to say the electrodes or separators are not dry. It is now proposed by the invention to provide an additional electrolyte volume in order to form the thermal arrangement, in other words to provide the nickel-metal hydride accumulator with more electrolyte than is necessary for ordinary operation of the accumulator. There is thus an excess of electrolyte, which increases the specific thermal capacity of the accumulator and forms the thermal arrangement in this regard.

The use of additional electrolyte is not free from drawbacks, in particular if the nickel-metal hydride accumulator is to be used as an accumulator for a vehicle, for example a hybrid vehicle. The additional use of electrolyte adds additional weight. The constant effort to reduce weight, in particular in vehicle construction, is thus counteracted. However, it has surprisingly been found that the drawback of increased weight is more than offset by the advantage of increased thermal capacity. In particular, this is because the service life of the accumulator can be drastically increased, which, in contrast to previously known accumulators, helps to avoid maintenance costs incurred by replacement. Furthermore, material and energy resources can be saved so that, overall, the advantages afforded by the invention outweigh any drawbacks. This was unexpected.

The additional electrolyte volume corresponds to 10% to 50%, preferably 15% to 40%, more preferably 20% of the electrolyte volume necessary for ordinary operation. Depending on the application and/or further measures for reducing the sensitivity of the accumulator to temperature, other values can also be applied. The level of the electrolyte is preferably 5 mm to 80 mm, more preferably 10 mm to 70 mm, most preferably 20 mm to 50 mm above the separators insulating the electrodes from one another.

The electrodes and the electrolyte are received by a plastics material housing which provides a pressure relief valve. The pressure relief valve ensures that an excessive overpressure does not form inside the accumulator housing. It is even preferable for the accumulator according to the invention to operate in the low pressure range, so that the consumption of electrolyte is minimised. The increased thermal capacity can thus advantageously be kept at a high level over the service life of the accumulator by additional electrolyte.

In this regard it is further proposed to provide the accumulator with a recombination element housed inside the accumulator. Owing to the recombination element, the oxygen and hydrogen formed during overcharging of the accumulator are recombined to form water, as a result of which the accumulator finds itself in the low-pressure range in almost all operating states, the electrodes thus being pressed together, which minimises the distance between the electrodes. A reduction in the internal resistances is thus achieved.

In order to mechanically stabilise the accumulator housing, in particular for operation of the accumulator in the low pressure range, a stiffening element is used in accordance with a further feature of the invention. This is preferably arranged above the electrolyte level inside the plastics material housing of the accumulator.

In particular for reasons of safety, a backfire protection may be provided in accordance with a further feature of the invention, for example in the form of a porous frit which is arranged upstream of the pressure relief valve in the direction of gas discharge.

Nickel-plated non-woven materials are preferably used as electrode support materials. In addition, other nickel-plated metal supports, such as stretched expanded metals or metal foams can also be used. The electrode support structure is filled with the active materials in such a way that a paste is used which, in addition to the electrochemically active materials and the binder, also contains a gelling agent which enables uniform packing out of the structure. Different water-soluble long-chain polymers can be used as gelling agents and provide a high viscosity and volume stability of the pasty active mass. It is thus easier to charge the electrode support structure.

In accordance with a further feature of the invention the electrodes are inserted into separator pockets, that is to say are designed as “pocketed” electrodes. The separator pockets are preferably closed on three sides, for example by folding over, welding and/or the like.

The separator pockets are preferably formed of a permanently wettable polyolefin non-woven fabric or alternately of a polyamide non-woven fabric, wherein the separator pockets are contacted in this instance. In the case of the alternate use of a polyolefin non-woven material on the one hand and of a polyamide non-woven material on the other, the electrodes of both polarities are preferably pocketed in a respective non-woven material so that one type of electrode is inserted into the polyolefin separator and the other type of electrode is inserted into the polyamide separator. This alternating arrangement of the different separator materials and their contacting in the cell packet cause both separators to be permanently reliably wetted with electrolyte, thus preventing any drying out, even if the electrolyte level is low.

In particular an alkaline solution which is preferably formed of a mixture of lithium hydroxide, sodium hydroxide and/or potassium hydroxide is used as an electrolyte. The composition can be varied depending on use and requirements.

The positive electrode preferably has a nickel arrester and a binder-containing active mass based on nickel hydroxide. The active mass may also contain a gelling agent in addition to the electrochemically acting components.

The negative electrode has a metal support and a binder-containing active mass based on a hydrogen storage alloy. The binder-containing active mass of the negative electrode may also contain a gelling agent.

In particular, a nickel-plated non-woven fabric or another nickel structure either with or without an inner plastics material core may be considered as a support for the positive electrode.

An aqueous polymer solution is preferably used as a gelling agent.

A nickel-plated non-woven fabric may likewise be used as a support for the negative electrode. A nickel structure with or without an inner plastics material core may also be considered. Further, a nickel-plated expanded metal can be used, of which the metal content is between 50 and 170 mg/cm³.

The pressure relief valve is removable, which simplifies maintenance. The pressure relief valve is preferably set to open at an overpressure between 100 mbar and 2000 mbar. It is also formed in an automatically closing manner.

The excess electrolyte provided in accordance with the invention contributes significantly as a thermal arrangement to increasing the specific thermal capacity of the accumulator, whereby the temperature load is reduced and the risk of overheating is also minimised, both during operation of the accumulator and in the event of overcharging thereof. The ageing of the electrode is thus advantageously slowed so that the service life of the accumulator is increased, in particular at high charge throughputs. The removable pressure relief valve also makes it possible to carry out maintenance of the accumulator and to compensate for any electrolyte losses, if necessary.

### BRIEF DESCRIPTION OF THE DRAWING

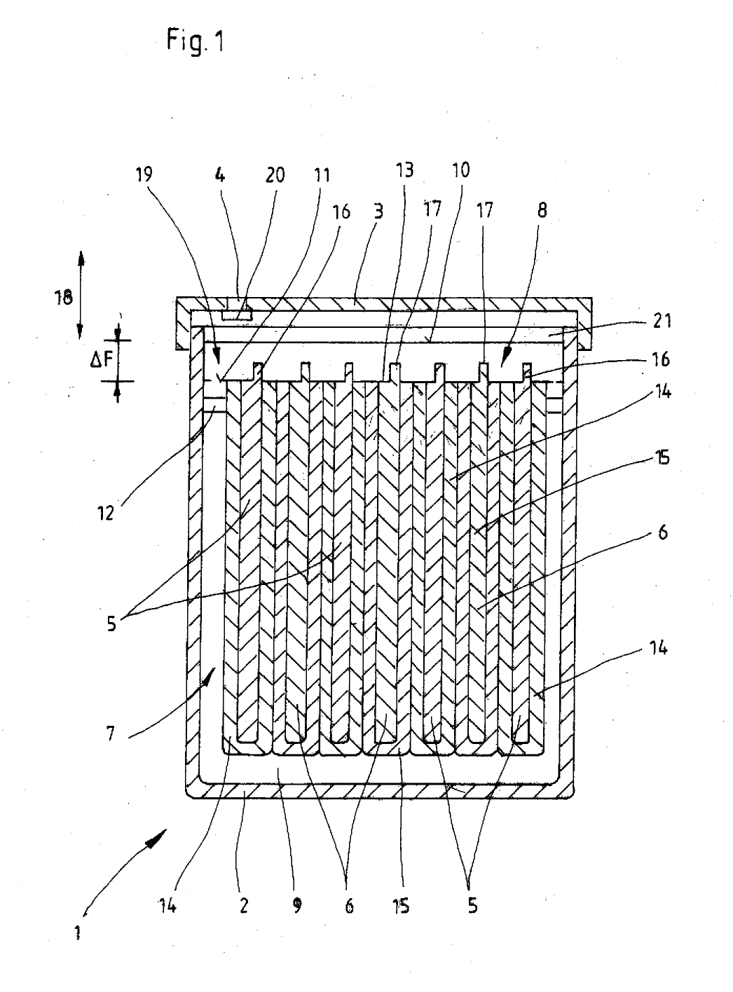

Further features and advantages of the invention will become clear from the following description on the basis of the single drawing, FIG. 1, which shows a schematic sectional representation of an accumulator according to the invention.

### DESCRIPTION OF PREFERRED EMBODIMENTS

FIG. 1 is a schematic sectional representation of a metal hydride accumulator 1. It has a plastics material housing 2, which can be closed tightly by means of a cover 3. A pressure relief valve 4 is inserted tightly in an opening in the cover 3 and carries a backfire protection 20 internally.

Positive nickel hydroxide electrodes 5 and negative metal hydride electrodes 6 are arranged in the accumulator housing 2. The electrodes are mounted in a suspended manner, for which purpose the accumulator housing 2 provides corresponding supports 12 in the form of strips. The electrodes 5 and 6 are inserted into pocket-shaped separators. The positive electrodes 5 are arranged in the separator pockets 14 and the negative electrodes 6 are arranged in the separator pockets 15. A polyolefin non-woven material is used as a material for the separator pockets 14. The separator pockets 15 for the negative electrodes are formed from a polyamide separator non-woven fabric.

The electrodes 5 and 6 have lugs 16 and 17 which are used for electrical connection. A bracing is provided by means of a stiffening element 21 for additional stabilisation of the accumulator housing 2. The stiffening element 21 is formed above the electrolyte level 10 in the vertical direction 18.

An electrolyte 9 is also located inside the housing 2. It washes over the electrodes 5 and 6 and the separator pockets 14 and 15. A level 11 of the electrolyte 9 which reaches as far as the upper edge 13 of the separator pockets 14 and 15 is necessary for ordinary operation of the accumulator 1, as is indicated in FIG. 1 by the broken line. In accordance with the invention the accumulator 1 has an additional electrolyte volume 8. Together with the electrolyte volume 7 necessary for ordinary operation, the level 10 is given. The difference between the level 11 and the level 10 is illustrated in the drawing as the level difference Δ F.

The additional electrolyte volume 8 forms a thermal arrangement 19, thus increasing the specific thermal capacity of the accumulator 1.

The application incorporates by reference the entire disclosure of German patent application DE 10 2010 046 647.6 having a filing date of 27 Sep. 2010 of which application priority is claimed for the instant application for patent.

While specific embodiments of the invention have been shown and described in detail to illustrate the inventive principles, it will be understood that the invention may be embodied otherwise without departing from such principles.

### LIST OF REFERENCE NUMERALS

1 accumulator
2 housing
3 cover
4 pressure relief valve
5 positive nickel hydroxide electrode
6 negative metal hydride electrode
7 electrolyte volume
8 additional electrolyte volume
9 electrolyte
10 electrolyte level with additional electrolyte volume 8
11 electrolyte level without additional electrolyte volume 8
12 support
13 edge
14 separator pocket
15 separator pocket
16 lug
17 lug
18 vertical direction
19 thermal arrangement
20 backfire protection
21 stiffening element
Δ F difference in level (enveloping height)

What is claimed is:

1. A nickel-metal hydride accumulator for industrial applications, the accumulator comprising:
positive nickel hydroxide electrodes and, separated therefrom, negative metal hydride electrodes;
an alkaline electrolyte surrounding the positive and negative electrodes;
a thermal arrangement which increases a specific thermal capacity of the accumulator and is formed by an additional electrolyte volume;
a plastics material housing which receives the positive and negative electrodes and the electrolyte, wherein the housing comprises a pressure relief valve.

2. The accumulator according to claim 1, wherein the additional electrolyte volume corresponds to 10% to 50% of an electrolyte volume necessary for ordinary operation of the accumulator.

3. The accumulator according to claim 1, comprising separators that insulate the electrodes from each another, wherein a level of the electrolyte is 5 mm to 80 mm above the separators.

4. The accumulator according to claim 1, comprising a backfire protection arranged upstream of the pressure relief valve in a direction of gas discharge.

5. The accumulator according to claim 1, comprising a recombination element arranged inside the plastics material housing.

6. The accumulator according to claim 1, comprising a stiffening element for the plastics material housing, wherein the stiffening element is arranged above a level of the electrolyte inside the plastics material housing.

7. The accumulator according to claim 1, wherein the positive and negative electrodes have a nickel-containing electrode support structure.

8. The accumulator according to claim 7, wherein the electrode support structure is formed of a nickel-plated non-woven material.

9. The accumulator according to claim 1, comprising pockets made of separator material, wherein the positive electrodes or the negative electrodes are arranged in the pockets.

10. The accumulator according to claim 9, wherein the separator material is a polyolefin or a polyamide non-woven material.

11. The accumulator according to claim 1, comprising pockets made of separator material, wherein the positive electrodes and the negative electrodes are arranged in the pockets

12. The accumulator according to claim 11, wherein the separator material is a polyolefin or a polyamide non-woven material.

13. The accumulator according to claim 1, wherein the electrolyte is an alkaline solution which is formed of a mixture of lithium hydroxide, sodium hydroxide and/or potassium hydroxide.
